(19) United States
(12) Patent Application Publication
(10) Pub. No.: US 2007/0163256 A1
(43) Pub. Date: Jul. 19, 2007

(54) Apparatus and methods for gas production during pressure letdown in pipelines

(76) Inventors: Duncan McDonald, Victoria (CA); Richard A. Bailey, Sidney (CA)

Correspondence Address: KLARQUIST SPARKMAN, LLP, 121 SW SALMON STREET, SUITE 1600, PORTLAND, OR, 97204, US

(21) Appl. No.: 10/585,238

(22) PCT Filed: Dec. 22, 2004
(86) PCT No.: PCT/CA04/02183

§ 371 Date: Jun. 29, 2006

(51) Int. Cl. B60K 6/04

(52) U.S. Cl. 60/597

(57) ABSTRACT

Apparatus, methods and an installation are provided for reducing pressure in a carrier line, such as a natural gas pipeline, and capturing the resultant waste energy. The apparatus is comprised of a flow converter for gaseous communication with a carrier line and an electricity generator mechanically linked to the flow converter for transforming the excess energy resulting from the pressure drop into electrical energy, such that in use, the energy released from the pressure drop can be captured and utilized for the production of gases such as hydrogen.

### FIELD OF THE INVENTION

The present invention relates to apparatus located at pipeline pressure reduction sites for capturing energy and utilizing the cooling stream. Further, the invention provides for methods of use of the captured energy and the cooling stream. More specifically, the invention relates to using the pressure reduction in natural gas pipelines for the production and efficient storage of processed gases.

### BACKGROUND OF THE INVENTION

Thousands of kilometres of high-pressure natural gas transmission pipelines have been installed in North America and Europe to link producing fields with major energy consumption locations in almost every city and town. In North America many of these systems are interconnected with storage facilities providing a mature, highly integrated clean energy delivery network with >5.4 million hp of gas turbine drivers installed as of 1994 and >232 gas storage facilities as of 1997 (aggregate capacity of >3.3 Tcf). High-pressure natural gas mainline transmission systems are known to operate at up to 1,000-2,000 psi with injection and booster compression power (5,000-30,000 hp size range) provided throughout the network. Local distribution companies (LDC's) are known to reduce the gas pressure to ˜60 psi and distribute the gas within cities to major industries and residential customers; most often this pressure reduction takes place using simple isenthalpic valves and regulators that recover no usable energy.

Industry practice has been to use isenthalpic valves to reduce pressure from mainline natural gas transmission conditions to local distribution facilities at meter (or letdown) stations strategically located near city gates; such valves recover no potential energy and incur a cost for heating the gas to avoid high pressure blow-by of valve packing, hydrate formation and downstream frost bulges. Hence, although pressure reduction from mainline transmission conditions to local distribution networks through valves is a reliable and simple technique, it is an energy inefficient process.

For approximately 40 years the natural gas production/transmission and petrochemical industries have used expansion turbines to reduce the pressure of natural gas and extract rotational energy that can be used to power a gas compressor or electrical generator; such turbo-expanders cause cooling of the gas which is useful for dew point control and removal of ethane and heavier hydrocarbons. For a similar period turbo-expanders have been used in refrigeration systems and in the production of liquefied natural gas (LNG). Recently the Idaho National Engineering and Environmental Laboratory (INEEL) has designed, and in conjunction with Pacific Gas and Electric Company and others, in June 2002, commissioned in Sacramento Calif. a 10,000 gal/day LNG plant incorporating a turbo-expander driven by pressure letdown from a 500 psi transmission line; INEEL, has announced plans to build a second plant in Los Angeles and a third in Idaho. To our knowledge, the energy and cooling stream produced during pressure letdown have not been utilized to produce and compress a second gas stream.

Hydrogen Production:

Industrial scale production of hydrogen by steam reformation of methane is a proven process used at the point of consumption to avoid transportation of hydrogen. While the process is reasonably energy efficient, it results in massive emissions of dilute CO₂ to the atmosphere. At smaller scale the electrolysis of water produces hydrogen and oxygen without direct CO₂ emissions. Unfortunately, the expense of electricity has hampered the adoption of this method of producing hydrogen. In addition, indirect CO₂ emissions may occur if the electricity is produced at coal or gas fired power plants. Wind power and photovoltaic sources are possible, but are intermittent, unpredictable and frequently remote. For these reasons, at the present time merchant supply of hydrogen is usually trucked at high pressure in tube trailer quantities from dedicated methane reforming plants when surplus capacity is available. This unfortunately generates greenhouse gases and criteria air contaminants (CAC) emissions during transport. Larger quantities of hydrogen are also moved in liquid form at very low temperatures in special cryogenic trailers like those used for liquid oxygen and liquid nitrogen transport. The excess capacity of these plants, which are frequently remote from the merchant demand, is presently being reduced due to expansion of internal demand for such uses as heavy oil upgrading.

Hydrogen has a low energy density. As a result, hydrogen fueled vehicles have limited traveling range. The range could be increased by increasing the amount of hydrogen that can be carried. As there is a practical limit to the volume of fuel that can be carried, an alternate approach is to compress the gas. Unfortunately, when a gas is compressed, heat is imparted into the system and this causes expansion of the gas. Hence, after refueling, if the temperature drops, the volume of hydrogen decreases, and a vehicle that ostensibly was completely refueled, may, for example, be only ¾ filled. This again limits the traveling range of the vehicle.

It is an object of the invention to overcome the deficiencies in the prior art.

### SUMMARY OF THE INVENTION

The present invention provides an apparatus and methods for reducing pressure in a carrier line, such as a natural gas pipeline, capturing at least a portion of the resultant waste energy and utilizing the resultant cooling stream. The waste energy can be utilized for the production and compression of a number of processed gases, while the cooling stream is used to assist in compressing the processed gas. The apparatus is for locating at natural gas pressure letdown stations. In these locations, the apparatus can, for example, but not to be limited to, form the basis for hydrogen gas refueling stations for hydrogen fueled vehicles. Such installations would therefore be located throughout urban areas that have natural gas pipelines, providing drivers with ready access to fuel.

In an embodiment of the invention, the apparatus comprises a flow converter which is any device that extracts work/energy in transforming a gas flow from a first volume/flow rate at a first pressure to a second volume/flow rate at a second pressure, wherein the first volume/flow rate is less than the second volume/flow rate and/or the first pressure is greater than the second pressure, an electricity generator and a water extractor. The apparatus further comprises a processed gas generator and processed gas collector electrically linked to said electricity generator for the production of a processed gas, such that in use, at least a portion of the energy released from the pressure drop can be captured and utilized for the production of a processed gas.

In another aspect of the invention, the apparatus comprises at least one heater proximate to said flow expander.

In another aspect of the invention, the at least one heater is upstream from said flow expander.

In another aspect of the invention, the at least one heater is downstream from said flow expander.

In another aspect of the invention, the apparatus further comprises a gas line in communication with said processed gas generator for transporting a gas.

In yet a further aspect of the invention, the apparatus comprises a collection chamber in gaseous communication with said gas generator.

In another aspect of the invention, the processed gas generator is an electrolyser.

In yet another aspect of the invention, the electrolyser is a water electrolyser.

In yet another aspect of the invention, the apparatus further comprises a compressor for operable connection to said collection chamber and electrically connectable with said electricity generator.

In yet another aspect of the invention, the compressor is a mechanical compressor.

In another aspect of the invention, the apparatus further comprises at least one heat exchanger in communication with said collection chamber for accepting a cooling stream and cooling said collection chamber.

In yet another aspect of the invention there are two heat exchangers.

In another aspect of the invention a link is provided to send excess energy to a power grid.

In another aspect of the invention, the apparatus further comprises at least one heater proximate to said flow converter to heat said carrier line.

In another aspect of the invention, the heat source is upstream of said flow converter.

In another aspect of the invention, the heat source is dowstream of said flow converter.

In another aspect of the invention, the apparatus comprises two heaters.

In yet another aspect of the invention, a secondary electrical device is provided.

In another aspect of the invention the apparatus the water extractor comprises a methanol injection and recovery loop operably linked with a carrier line, such that in use, methanol is injected into a primary stream.

In yet another aspect of the invention the methanol injection and recovery loop comprises a methanol tank operably linked with an injection pump, said injection pump in fluid communication with a carrier line for injecting methanol into a primary stream, a methanol separation tank, said methanol separation tank in fluid communication with a carrier line downstream of said injection pump, for recovering methanol and in fluid communication with said methanol tank.

In another aspect of the invention, the water extractor comprises an absorbent selected from the group consisting of triethylene glycol, diethylene glycol, ethylene glycol and methanol.

In another aspect of the invention, the water extractor comprises an adsorbent selected from the group consisting of alumina, silica gel and molecular sieves.

In another aspect of the invention, the water extractor comprises an expansion refrigerator.

In another aspect of the invention, the water extractor comprises an injector of hydrate point depressants.

In another embodiment of the invention, the apparatus comprises a turbo-expander for gaseous communication with a carrier line.

In another aspect of the invention, the flow converter is an expansion engine.

In a second aspect of the invention, an apparatus for reducing pressure in a carrier line such as natural gas pipelines and capturing at least a portion of the resultant waste energy is provided. The apparatus comprises a flow converter for gaseous communication with a carrier line, wherein a first end of said flow converter accepts high pressure gas in a primary stream, there is a pressure drop through the flow converter and then a lower pressure pipeline gas is released from a second end of said flow converter to a carrier line, an electricity generator mechanically linked to said flow converter for transforming the excess energy resulting from the pressure drop into electrical energy, a hydrogen gas generator electrically linked to said electricity generator for the production of hydrogen gas and a chamber in communication with said hydrogen gas generator for collecting hydrogen gas, such that in use, at least a portion of the energy released from the pressure drop is captured and utilized for the production of hydrogen gas.

In another aspect of the invention, the apparatus comprises at least one heater proximate to said flow expander.

In another aspect of the invention, the at least one heater is upstream from said flow expander.

In another aspect of the invention, the at least one heater is downstream from said flow expander.

In another aspect of the invention, the hydrogen gas generator is an electrolyser.

In another aspect of the invention, the apparatus further comprises a pipeline in communication with said electrolyser for transporting hydrogen gas.

In yet a further aspect of the invention, the apparatus comprises a collection chamber in fluid or gaseous communication with said electrolyser and collector.

In yet another aspect of the invention, the apparatus further comprises hydrogen compressor, said compressor for operable connection to said collection chamber and electrically connectable with said electricity generator.

In yet another aspect of the invention, the compressor is a mechanical compressor.

In yet another aspect of the invention, the compressor is a hydrogen receiver and hydride reservoirs.

In another aspect of the invention, the apparatus further comprises at least one heat exchanger in communication with said collection chamber for accepting a cooling stream and cooling said collection chamber.

In yet another aspect of the invention there are two heat exchangers.

In another aspect of the invention a link is provided to send excess energy to a power grid.

In another aspect of the invention the water extractor comprises a methanol injection and recovery loop operably linked with a carrier line, such that in use, methanol is injected into a primary stream.

In yet another aspect of the invention the methanol injection and recovery loop comprises a methanol tank operably linked with an injection pump, said injection pump in fluid communication with a carrier line for injecting methanol into a primary stream, a methanol separation tank, said methanol separation tank in fluid communication with a carrier line downstream of said injection pump, for recovering methanol and in fluid communication with said methanol tank.

In another aspect of the invention, the water extractor comprises an absorbent selected from the group consisting of triethylene glycol, diethylene glycol, ethylene glycol and methanol.

In another aspect of the invention, the water extractor comprises an adsorbent selected from the group consisting of alumina, silica gel and molecular sieves.

In another aspect of the invention, the water extractor comprises an expansion refrigerator.

In another aspect of the invention, the water extractor comprises an injector of hydrate point depressants.

In another embodiment of the invention, the apparatus comprises a turbo-expander for gaseous communication with a carrier line.

In another aspect of the invention, the flow converter is an expansion engine.

In another aspect of the invention a method of reducing pressure in a carrier line such as a natural gas pipeline and capturing at least a portion of the resultant waste energy is provided. The method comprises expanding a pipeline gas in a carrier line, transforming the resultant mechanical energy to electrical energy, utilizing said electrical energy to generate a processed gas and collecting said processed gas.

In another aspect of the invention, the method further comprises heating the pipeline gas.

In another aspect of the invention, the method further comprises cooling the processed gas.

In a further aspect of the invention, the processed gas is cooled by a cooling stream.

In yet another aspect of the invention, the method further comprises compressing the processed gas.

In a further aspect of the invention, the processed gas is hydrogen gas.

In yet another aspect of the invention, the hydrogen gas is generated by electrolysis.

In yet another aspect of the invention, the hydrogen gas is produced by pyrolysis.

In yet another aspect of the invention, the hydrogen gas is produced thermochemically.

In yet another aspect of the method of the invention, the surplus power is released to a power grid.

In another aspect of the invention, a method for fueling hydrogen fueled vehicles by reducing pressure in a carrier line such as a natural gas pipeline and capturing at least a portion of the resultant waste energy is provided. The method comprises expanding a gas in a carrier line, transforming the resultant mechanical energy to electrical energy, utilizing said electrical energy to generate hydrogen gas, collecting said hydrogen gas, compressing said hydrogen gas and dispensing said hydrogen gas.

In another embodiment of the invention, an installation for fueling hydrogen fueled vehicles by reducing pressure in a carrier line such as a natural gas pipeline and capturing at least a portion of the resultant waste energy is provided. The installation comprises a flow converter for gaseous communication with a carrier line, wherein a first end of said flow converter accepts high pressure pipeline gas in a primary stream, there is a pressure drop through the flow converter and then a lower pressure gas is released from a second end of said flow converter to a carrier line, as a cooling stream, an electricity generator mechanically linked to said flow converter for transforming the excess energy resulting from the pressure drop into electrical energy, a hydrogen gas generator electrically linked to said electricity generator for the production of hydrogen gas, a chamber in communication with said hydrogen gas generator for collecting hydrogen gas and a hydrogen gas dispenser.

In a further aspect of the invention, the hydrogen gas generator is an electrolyser.

In another aspect of the invention, a system for production of a processed gas is provided, comprising:

an electricity generator configured to produce electrical power based on a pressure drop in a gas flow; and

a processed gas generator electrically linked to the electrical generator for the production of the processed gas.

In yet another aspect of the invention, a system for production of a processed gas is provided comprising:

a flow converter configured to receive a pipeline gas flow at a first pressure and deliver the pipeline gas flow at a second pressure, wherein the first pressure is greater than the second pressure;

an electricity generator in communication with the flow converter and configured to produce electrical power based on conversion of the pipeline gas flow from the first pressure to the second pressure; and

a processed gas generator electrically linked to the electrical generator configured to produce the processed gas.

In another aspect of the invention, the system comprises at least one heater proximate to said flow expander.

In another aspect of the invention, the at least one heater is upstream from said flow expander.

In another aspect of the invention, the at least one heater is downstream from said flow expander.

In yet another aspect of the invention, a system is provided wherein the processed gas is hydrogen gas.

In a further aspect of the invention, the flow converter of the system is configured to cool the processed gas based on the pipeline gas flow at the second pressure.

In yet another aspect of the invention, the processed gas generator of the system comprises an electrolyser.

In a further aspect of the invention, the system comprises a gas line in gaseous communication with the processed gas generator for transporting a gas.

In yet another further aspect of the invention, the system further comprises a collection chamber in gaseous communication with the processed gas generator.

In another aspect of the invention, the system comprises compressor, the compressor for operable connection to the collection chamber and electrically connectable with the electricity generator.

In one embodiment of the invention, the compressor of the system is a mechanical compressor.

In another embodiment of the invention the compressor comprises a hydrogen receiver and hydride reservoirs.

In another aspect of the invention, the system comprises at least one heat exchanger in communication with the collection chamber for accepting the cooling stream and cooling the collection chamber.

In a further aspect of the invention, there are two heat exchangers in the system.

In yet another aspect of the invention, the system further comprises to send excess energy to a power grid.

In another aspect of the invention the water extractor comprises a methanol injection and recovery loop operably linked with a carrier line, such that in use, methanol is injected into a primary stream.

In yet another aspect of the invention the methanol injection and recovery loop comprises a methanol tank operably linked with an injection pump, said injection pump in fluid communication with a carrier line for injecting methanol into a primary stream, a methanol separation tank, said methanol separation tank in fluid communication with a carrier line downstream of said injection pump, for recovering methanol and in fluid communication with said in methanol tank.

In another aspect of the invention, the water extractor comprises an absorbent selected from the group consisting of triethylene glycol, diethylene glycol, ethylene glycol and methanol.

In another aspect of the invention, the water extractor comprises an adsorbent selected from the group consisting of alumina, silica gel and molecular sieves.

In another aspect of the invention, the water extractor comprises an expansion refrigerator.

In another aspect of the invention, the water extractor comprises an injector of hydrate point depressants.

In another embodiment of the invention, the system comprises a turbo-expander for gaseous communication with a carrier line.

In another aspect of the invention, the flow converter comprises an expansion engine.

### BRIEF DESCRIPTION OF THE DRAWINGS

FIG. 1 is a schematic drawing of the apparatus in accordance with an embodiment of the invention for the production of hydrogen and oxygen.

FIG. 2 is a schematic drawing of the apparatus in accordance with an embodiment of the invention for the extraction of carbon dioxide.

FIG. 3 is a schematic drawing of the apparatus in accordance with an embodiment of the invention using an internal combustion engine.

FIG. 4 is a schematic drawing of the apparatus in accordance with an embodiment of the invention for advanced combustion plants.

FIG. 5 is a schematic drawing of the apparatus in accordance with an embodiment of the invention using a fired heater and showing power coming from a peak shaving plant.

FIG. 6 is a schematic drawing of the apparatus in accordance with an embodiment of the invention showing an external source, such as an external heat or refrigerator load for or a fuel cell for use as a heat source.

### DESCRIPTION

The use of the energy and cooling stream from the pressure letdown for the production and storage of gases is described using hydrogen by way of example, but not to be limiting.

In the preferred embodiment, the capture and utilization of waste compression energy combined with the utilization of a cooling stream from existing natural gas transport offers the potential to act as a necessary bridging step toward the hydrogen economy by producing low emission (full cycle) hydrogen at strategic locations adjacent to major cities where it can play a vital role.

Capture of the wasted energy from pressure letdown has been demonstrated. For example, U.S. Pat. No. 6,167,692 discloses a method in which a fuel gas expander device is employed in a power generation plant to utilize the difference between the fuel gas source pressure and the combustor/burner pressure in the power generating plant, resulting in improved power output and efficiency of the plant.

US patent application publication number 20030292343, discloses apparatus and methods for liquefaction of natural gas by using the energy from a flow converter. A portion of the stream of natural gas is portioned off and passes through the turbo-expander. The pressure drop results in work output which is utilized to drive a gas compressor.

Utilization of the waste compression energy does not consume any natural gas. Therefore, the cost of the hydrogen produced can be de-coupled from the value of the gas and therefore independent of international energy price volatility. The hydrogen can be produced as needed at the point of consumption, thereby minimizing storage and handling costs which are critical if fuel cells are to penetrate the transportation sector.

Major benefits include distributed production of hydrogen from under-utilised pressure drop; thereby providing convenient sources of low emission hydrogen at accessible points to support the anticipated market growth of both mobile and fixed fuel cells, for example but not to be limited to, polymer electrolyte membrane (PEM) fuel cells.

The present invention will produce hydrogen with a clean full-cycle environmental profile that otherwise is not possible starting with fossil fuels; unlike wind and photo-voltaic sources of clean power, the proposed concept will generate green electricity and hydrogen on a consistent 24/7/52 basis.

There are numerous methods for the production of hydrogen. Methods for the electrolysis of water are known. One representative electrolytic cell configuration for electrolysis of water would comprise an anode (+) and cathode (−) separated by a physical barrier, e.g., porous diaphragm comprised of asbestos, microporous separator of polytetrafluoroethylene (PTFE), and the like. As disclosed in U.S. Pat. No. 6,638,413, an aqueous electrolyte containing a small amount of ionically conducting acid or base fills the anode and cathode compartments of the cell. With application of a voltage across the electrodes hydrogen gas is formed at the cathode and oxygen is generated at the anode.

As disclosed in U.S. Pat. No. 6,630,119, hydrogen can be produced by pyrolysis. There are also numerous thermochemical methods of producing hydrogen. The following is a summary of the methods:

[Conversion Reaction of Carbon Monoxide]
CO+H.sub.2O═CO.sub.2+H.sub.2

The above-mentioned conversion reaction is conducted using iron oxide (Fe.sub.3 O.sub.4) or a catalyst in a group of zinc oxide-copper. NaY-type zeolite can also be used as a catalyst.

[Direct Decomposition of Water Through Triiron Tetroxide (Fe.sub.3O.sub.4)]

This method, which was tested by New Energy and Industrial Technology Development Organization (Public Corporation of Japan), comprises eight (8) processes of an iron-steam group.

[Cycle of Halogen Group]
CaBr.sub.2+H.sub.2O═CaO+2HBr (700-750.degree. C.)
CaO+½Br.sub.2=CaBr+½O.sub.2(500-600.degree. C.)
Fe.sub.3O.sub.4+8HBr=3FeBr.sub.2+4H.sub.2O+Br.sub.2 (200-300.degree. C.)
3FeBr.sub.2+4H.sub.2O═Fe.sub.3O.sub.4+6HBr+H.sub.2 (500-650.degree. C.)
[Iron-Bromine Cycle]

A cycle for producing hydrogen gas is conducted by Osaka National Research Institute(Public Corporation of Japan), using the following equations:
3FeBr.sub.2+4H.sub.2O═Fe.sub.3O.sub.4+6HBr+H.sub.2 (650.degree. C.)
Fe.sub.3O.sub.4+8HBr=FeBr.sub.4+4H.sub.2O+Br.sub.2 (up to 200.degree. C.)
SO.sub.2+Br.sub.2+2H.sub.2O═H.sub.2 SO.sub.4+2HBr (up to 80.degree. C.)
H.sub.2 SO.sub.4=H.sub.2O+SO.sub.2+½O.sub.2 (800.degree. C.)
[Oxide Cycle]

A cycle for producing hydrogen gas is conducted by Los Alamos National Laboratory, and it is reported that it proceeds up to 40 cycles using the following equations:
(SrO)yUO(3-x)+(3-y)Sr(OH).sub.2=(550.degree. C.)
Sr.sub.3 UO.sub.6+(3-y-x)H.sub.2O+xH.sub.2
Sr.sub.3 UO.sub.6+(3-y)H.sub.2O=(SrO)yUO3+(3-y)Sr(OH).sub.2 (90.degree. C.)
(SrO)yUO3=(SrO)yUO(3-x)+x/2O.sub.2 (600.degree. C.)
[Sulfur Group Cycle]

This is a proposed cycle for producing hydrogen gas by combining the following multistage reactions:
H.sub.2O+Cl.sub.2=2HCl+½O.sub.2 (800.degree. C.)
2HCl+S+FeCl.sub.2=H.sub.2S+FeCl.sub.3 (100.degree. C.)
H.sub.2S=H.sub.2+½S.sub.2 (800.degree. C.)
2FeCl.sub.3=2FeCl.sub.2+Cl.sub.2

Another method uses concentrated solar radiation to heat water vapor in order to dissociate the water. Alternatively, energy from the turbo-expander could be used to heat the water vapour. The process takes place at operating temperatures in the neighborhood of 2500K and is described by the following reactions:
H₂O→HO+H
HO→H+O
2H→H₂
2O→O₂

The yield is expected to vary with temperature.

Hydrogen is separated from a hot mixture of water splitting products by gas diffusion through a porous ceramic membrane. It has been concluded by theory (“Photocatalytic Generation of Hydrogen from Hydrogen Sulfide: An Energy Bargain”, Supriya V. Tambwekar, M. Subrahnanyam, Catalyst Section, Indian Institute of Chemical Technology, Hyderabad, India, 1997) that by quenching the hot gaseous mixture under optimal conditions it should be possible to recover 90% of the hydrogen formed.

The ceramic material may be a high temperature oxide ceramic, which has good mechanical and thermal stability up to 2500K. The reactor design is composed of a cylindrical zirconium housing, one end enclosed by a circular disk, and a zirconium crucible with porous wall at the other end. The housing is insulated by enclosing it in a cylindrical quartz bell jar, backed by a water-cooled metal flange. The superheated steam is introduced to the cavity at a constant flow rate. There are two streams of gas extracted from the reactor in parallel. One stream is collected by means of diffusion across a porous wall. This is the hydrogen-enriched stream. The other stream passes by the wall and is hydrogen depleted. Both streams are passed through cold traps, which would knock the moisture out of the gas.

It is also possible to derive hydrogen from hydrogen sulphide such as by electrolysis, however, removal of sulphur has been problematic, and human safety and equipment corrosion are major issues.

Hydrogen is problematic to transport due to its low volumetric energy density, thereby requiring significant energy expenditure for transport and storage as a compressed gas or for liquefaction. Hydrogen can be compressed using a gas compressor. The power required for compressing the gas may be derived from the turbo-expander and/or from the power grid, depending upon the energy requirements.

As disclosed in U.S. Pat. No. 4,995,235, an alternative apparatus for compressing hydrogen gas includes a hydrogen source, a hydrogen receiver, and a pair of hydride reservoirs. Each of the hydride reservoirs is capable of reacting with hydrogen gas therein and includes a jacket for the receipt of a heating and cooling medium therein. Each of the hydride reservoirs selectively receives the hydrogen gas from the hydrogen source and discharges the hydrogen gas to the hydrogen receiver. A heat pump or other means of generating heat, is operably connected to each of the hydride reservoirs by way of the heating and cooling medium for selectively cooling one of the hydride reservoirs while heating the other hydride reservoir and heating the one hydride reservoir while cooling the other hydride reservoir. There is also included a method of compressing hydrogen gas by using at least one hydride reservoir and a heat pump for transferring heat thereto and therefrom.

Cooling of the hydrogen allows for further compression of the gas. For example, decreasing the temperature to −110 C. is expected to increase the energy density of the fuel by 60%. While this alone will increase the travel range of a hydrogen fuel vehicle, two further advantages are also gained; a lower filling temperature reduces the volume loss that is currently associated with the temperature reduction following fueling; and a lower filling temperature decreases the time required for fueling.

There are a number of applications of the technology as follows by way of example:

### EXAMPLE 1

The apparatus is configured for the production of hydrogen by coupling an electrical generator to a turbo-expander, with a portion of the electricity produced used to generate hydrogen in one of two ways (see below); surplus electricity can be sold through the grid to existing industrial, commercial and residential customers.

In this example, the capacities of the turbo-expander and electrical generator are preferably balanced with an electrolyser or any other hydrogen generator, for example, but not to be limited to those listed above, so as to maximise the production of hydrogen and minimise electricity surplus to internal load. Careful selection of operating conditions has the potential to balance the cold sink to optimise hydrogen storage conditions.

### EXAMPLE 2

In a second example compression energy is recovered through a turbo-expander coupled to an electrical generator for electricity production. Turbo-expanders are common pieces of equipment in the natural gas production and chemical industries where they are used for dew point control and liquids extraction.

### EXAMPLE 3

In a third example the cooling stream at hydrogen production plants is used to capture CO₂ which can then be made available for enhanced oil recovery and sequestration opportunities. Large SMR (steam methane reforming) hydrogen plants use natural gas as the process stream and include an intermediate stream containing H₂, CO, CO₂ and CH₄. The present invention provides a turbo-expander to produce a cooling stream which is heat exchanged with the intermediate stream to extract CO₂ for EOR (Enhanced Oil Recovery) or sequestration.

The electrical output of the electrical generator is used to drive a gas compressor which raises the pressure of the intermediate stream thereby enabling continuous CO₂ condensation and removal as a liquid. After CO₂ removal, the enriched portion of the intermediate stream is returned to the hydrogen plant.

### EXAMPLE 4

In a fourth example the cooling stream is used to improve the energy efficiency and economics of front-end air separation in advanced recycle combustion systems (e.g. at CCGT power plants). Advanced recycle combustion plants include a front-end air separation plant that concentrates the oxygen content by cryogenic means. The present invention provides a turbo-expander to produce a cooling stream which is heat exchanged with the incoming air to increase the efficiency in front-end air separation. The concentrated oxygen is diluted with recycled flue gas high in CO₂ resulting in an oxidizing stream that when used for combustion will not produce NOₓ. The cold sink can also be used to reduce CO₂ capture costs as above.

### EXAMPLE 5

The fifth example is at LNG peakshaving plants to assist liquefaction and boiloff recapture by using the cooling stream. A portion of the process stream to the LNG plant is expanded to produce both electricity and a cooling stream by means of the turbo-expander. A gas compressor raises the pressure of the LNG tank boiloff which is cooled against the cooling stream and returned to the plant liquefaction cycle and/or storage.

The apparatus can be used to produce and efficiently store other gases. For example, the oxygen that is produced in electrolysis of water can also be cooled, compressed and stored. There are numerous methods for the production of oxygen, of which those that rely upon a source of electricity would be suited for the present technology.

### DETAILED DESCRIPTION OF THE PREFERRED EMBODIMENTS

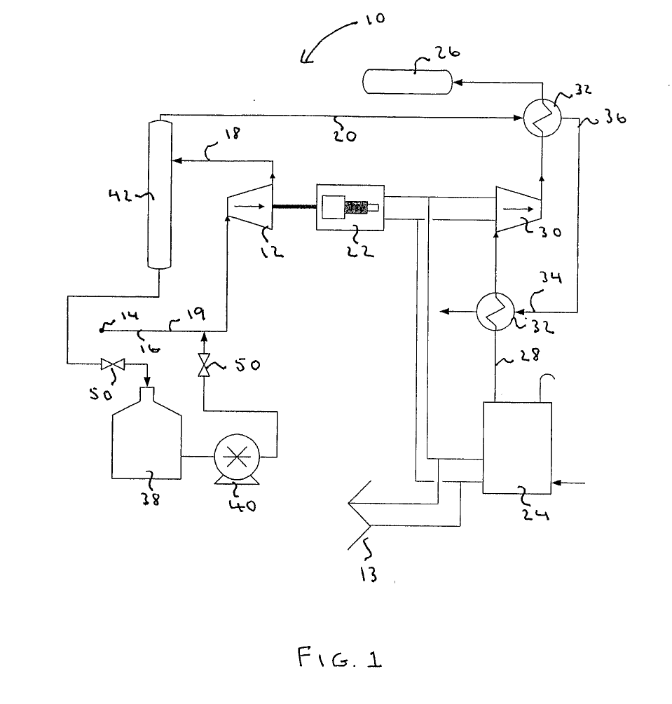

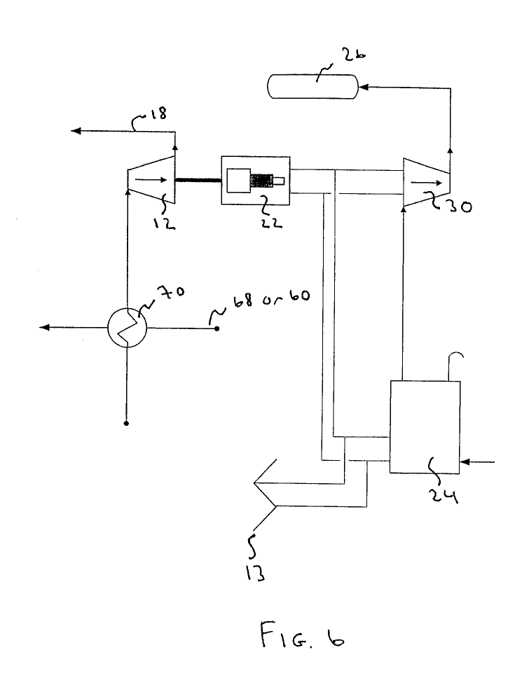

As shown in FIG. 1, an apparatus generally referred to as 10, comprises a turbo-expander 12 for gaseous communication with an upstream end 14 of a carrier pipe 16 at a first end 15 and for gaseous communication with a downstream end 18 of a carrier pipe 16 at a second end 17, wherein the first end 15 delivers high pressure pipeline gas to the turbo-expander 12 in a primary stream 19, there is a pressure drop through the turbo-expander 12 and the then lower pressure pipeline gas is delivered to the downstream end 18 of the carrier pipe 16 as a cooling stream 20. A heat source is preferably located upstream from the turbo-expander 12 and is preferably a high temperature fuel cell 60, as shown in FIG. 6. The turbo-expander 12 is mechanically linked to an electricity generator 22, thereby transforming the excess energy resulting from the pressure drop first into mechanical energy and then into electrical energy.

An electrolyser 24 is in electrical communication with the electricity generator 22. The electrolyser 24 is for the production of hydrogen gas. Production of hydrogen gas from the electrolysis of water requires that a suitable electrolyser 24 is employed. For example, but not to be limiting, a suitable electrolyser 24 is shown in U.S. Pat. No. 5,112,463.

An example of the apparatus for water electrolysis according to the present invention comprises an electrolysis cell, a gas-liquid separating mechanism and a power source, wherein the electrolysis cell is composed of a plurality of electrolysis compartments connected with each other in series, each electrolysis compartment has two electrode plates defining an anode and a cathode respectively; a membrane assembly made of an iron sieve(on the cathode side) and a nickel sieve(on the anode side) sandwiched therebetween a thin sheet of asbestos material is disposed between said electrode plates with iron sieve facing the cathode and nickel sieve facing the anode; said cathode and said iron sieve of the membrane assembly are spaced by a concave/convex iron net connected therebetween, said anode and said nickel sieve are spaced by a concave/convex nickel net connected therebetween such that said iron sieve and said nickel sieve form a part of the cathode and a part of the anode respectively; the electrode plates and the membrane assemblies have upper opening for gas exhaust and lower openings as liquid inlet near the upper and lower ends and perpendicular to the planes thereof; the plurality of electrolysis compartments are fastened together to form said electrolysis cell.

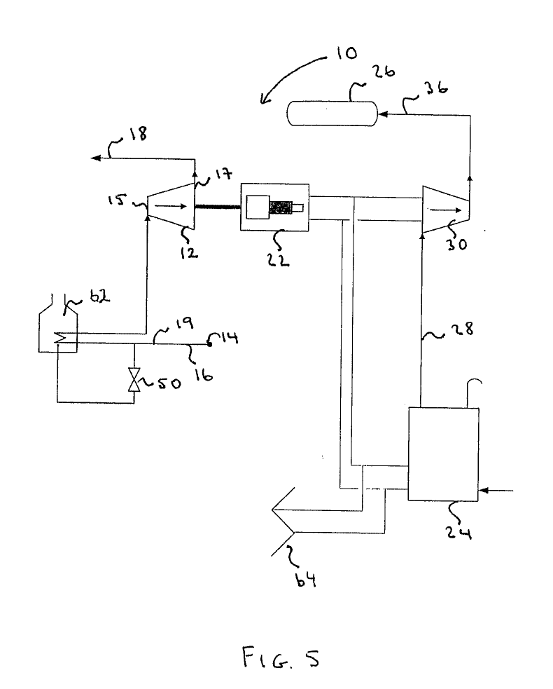

The processed gas provided is collected in a collection chamber 26 that is in gaseous communication with the electrolyser 24 by a hydrogen gas line 28 and which, in the preferred embodiment, is linked to a gas compressor 30 for compressing the processed gas. The gas compressor 30 may be mechanical as shown. Alternatively, other apparatus for compressing hydrogen may be provided, for example, but not to be limiting, the apparatus disclosed in U.S. Pat. No. 4,995,235. Regardless of the type of compressor employed, the electricity to run the compressor will be derived from either the turbo-expander 12, the power grid 13 or a combination thereof, depending upon the energy requirement of the compressor and the hydrogen generator. The power may also come from a peak shaving plant 64, as shown in FIG. 5.

As shown in FIG. 1 a pair of heat sinks 32 are located on the upstream end 34 and downstream end 36 of the hydrogen gas line 28. The heat sinks 32 accept coolant from the cooling stream 20, thereby cooling the hydrogen gas prior to storage in the collection chamber 26 and facilitating further compression of the hydrogen gas. Additionally, a methanol injection and recovery loop comprised of a methanol tank 38, an injection pump 40 and a methanol separation tank 42 are provided to minimize the content of water in the primary stream 19 so as to minimize the formation of ice during and after the pressure drop. Accordingly, the injection pump 40 injects methanol into the primary stream 19 upstream of the turbo-expander 12. The power to run the loop will be derived from either the turbo-expander 12, the power grid 13 or a combination thereof, depending upon the energy requirement of the compressor and the hydrogen generator.

The hydrogen gas, once cooled and compressed, may be stored or dispensed. Accordingly, dispensers are provided as would be known to one skilled in the art.

As shown in FIG. 1, the apparatus is controlled by numerous controls including switches, gauges, microprocessors, valves 50 and gates as would be apparent to one skilled in the art. The controls permit proportioning the amount of electricity that is used for processed gas production with the amount of electricity used for compressing the processed gas and the amount of electricity that enters into a power grid, as would be apparent to one skilled in the art. In this manner, operations can be optimized.

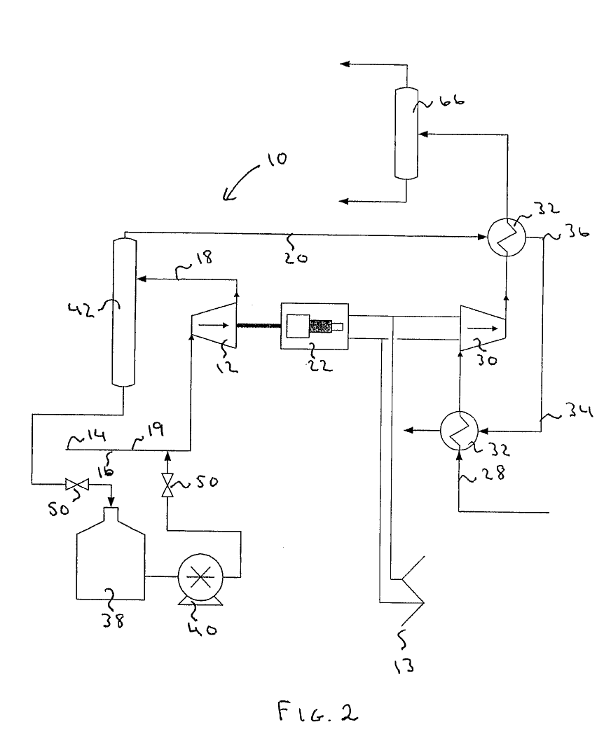

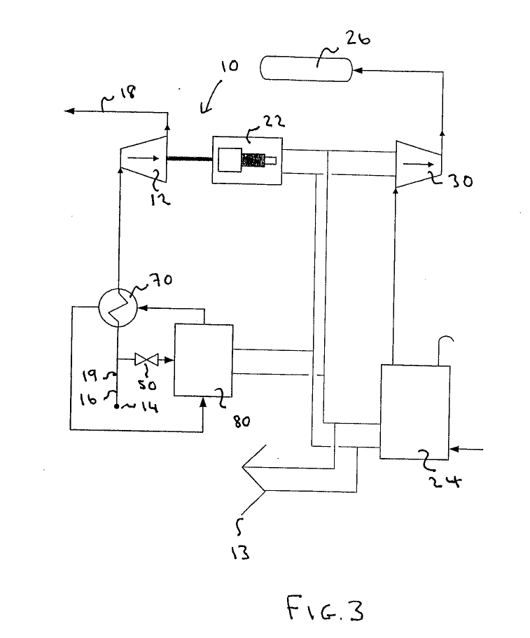

While specific embodiments of the invention have been described, such embodiments should not be considered as limiting the scope of the invention as construed in accordance with the accompanying claims. The turbo-expanded could be replaced with, for example, but not to be limiting, an expansion engine. The heat source can be located either upstream or downstream of the turbo-expander or expansion engine. The heat source can be an internal combustion engine 80, a fired heater 62 or an external heat/refrigerator load 68 by means of a heat exchanger 70, for example, but not meant to be limiting, as shown in FIGS. 3, 5, and 6, respectively. A number of different gases can be produced and stored using the above technology. Natural gas can be purified and carbon dioxide can be extracted in an extraction tank 66 and stored, as shown in FIG. 2. This purification can be effected by a number of methods, including methanol, glycol, molecular sieve of pressure swing adsorption, for example, but not to be limiting. In a further example, oxygen can be produced using electrolysis of water as described above. Further, the installation may be associated with any pressure letdown station, whether associated with natural gas pipelines or other pipelines for gases, such as feed lines for industries such as steel smelters. Additionally, a secondary electrical device may be provided that is operated on the excess power that might otherwise be sent to the power grid. Alternatively, if more power is required, a link to a power grid for supplemental electricity may be provided.

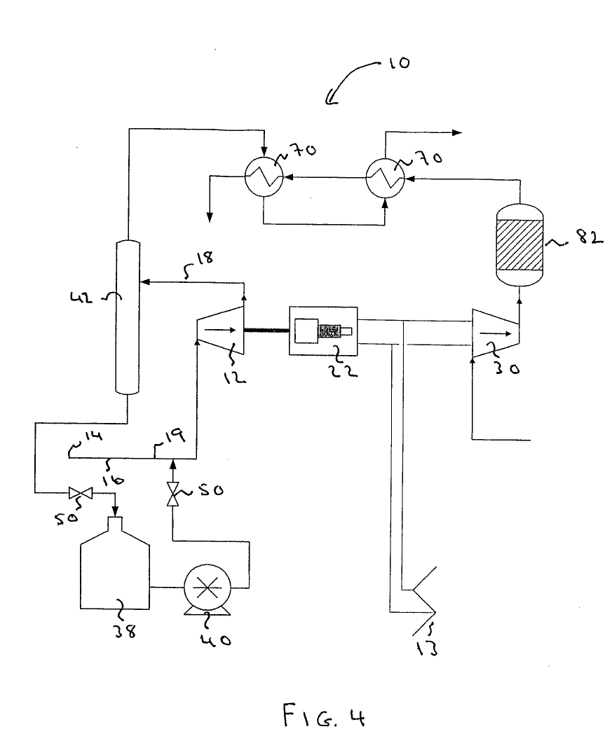

Similarly, methods other than methanol extraction are available for the extraction of water, including absorption using liquid desiccants, such as triethylene glycol, diethylene glycol, ethylene glycol and methanol, adsorption using solid desiccants such as alumina, silica gel and molecular sieves, inhibition by injection of hydrate point depressants, and dehydration by expansion refrigeration. The desiccants are contained in a desiccant bed 82, as shown in FIG. 4, which also shows an embodiment of the invention for use with advanced combustion plants.

1. An apparatus for reducing pressure in a carrier line and capturing the resultant waste energy and coolant through the production of a processed gas, said apparatus comprising:
a flow converter for gaseous communication with a carrier line, wherein the flow converter produces a pressure drop, the flow convertor including a first end configured to accept a high pressure pipeline gas in a primary stream and release a lower pressure pipeline gas at a second end of said flow converter to a carrier line;
a water extractor in communication with said carrier line;
an electricity generator mechanically linked to said flow converter for transforming at least a portion of the excess energy resulting from the pressure drop into electrical energy; and
a processed gas generator electrically linked to said electricity generator for the production of the processed gas, such that at least a portion of the energy released from the pressure drop is captured and utilized for the production of a processed gas.

2. The apparatus of claim 1, further comprising at least one heat source proximate to said flow converter to heat said carrier line.

3. The apparatus of claim 2 wherein said heat source is upstream of said flow converter.

4. The apparatus of claim 2 wherein said heat source is downstream of said flow converter.

5. The apparatus of claim 2, wherein said processed gas generator is an electrolyser electrically linked to said electricity generator for the production of a the processed gas.

6. The apparatus of claim 5 further comprising a collection chamber in gaseous communication with said processed gas generator for collecting said processed gas.

7. The apparatus of claim 6, further comprising a gas line in gaseous communication with said processed gas generator for transporting said processed gas.

8. The apparatus of claim 7 further comprising compressor means, said compressor means for operable connection to said collection chamber and electrically connectable with said electricity generator.

9. The apparatus of claim 8, wherein said compressor means is a mechanical compressor.

10. The apparatus of claim 9, further comprising at least one heat exchanger in communication with said collection chamber for accepting said cooling stream and cooling said collection chamber.

11-23. (canceled)

24. A method of reducing pressure in a carrier line such as a natural gas pipeline and capturing at least a portion of the resultant waste energy, said method comprising expanding a pipeline gas in a carrier line, transforming the resultant mechanical energy to electrical energy, utilizing said electrical energy to generate a processed gas and collecting said processed gas.

25. The method of claim 24 further comprising heating said pipeline gas.

26. The method of claim 25 further comprising cooling said processed gas.

27. The method of claim 26 wherein said processed gas is cooled by a cooling stream.

28. The method of claim 27 further comprising compressing said processed gas.

29. The method of claim 28 wherein said gas is hydrogen gas.

30-38. (canceled)

39. A system for production of a processed gas, comprising:
a flow converter configured to receive a pipeline gas flow at a first pressure and deliver the pipeline gas flow at a second pressure, wherein the first pressure is greater than the second pressure;
an electricity generator in communication with the flow converter and configured to produce electrical power based on conversion of the pipeline gas flow from the first pressure to the second pressure;
a water extractor in communication with said carrier line; and
a processed gas generator electrically linked to the electricity generator and configured to produce the processed gas.

40. The system of claim 39, wherein the processed gas is hydrogen gas.

41. The system of claim 39, wherein the flow converter is configured to cool the processed gas based on the pipeline gas flow at the second pressure.

42. The system of claim 39, wherein said processed gas generator is an electrolyser.

43-59. (canceled)
